(19) United States
(12) Patent Application Publication
(10) Pub. No.: US 2006/0118419 A1
(43) Pub. Date: Jun. 8, 2006

(54) Direct sample loading without loading buffer in horizontal gel electrophoresis

(76) Inventor: Stephen L. Chen, Portland, OR (US)

Correspondence Address: Stephen L Chen, 21109 NW Galice Ln, Portland, OR, 97229, US

(21) Appl. No.: 11/007,128

(22) Filed: Dec. 8, 2004

(51) Int. Cl. B01D 57/02; G01N 27/447

(52) U.S. Cl. 204/470; 204/615

(57) ABSTRACT

A hydrophobic liquid is utilized to enable direct sample loading from reactions tubes to gel sample wells without using loading buffer in horizontal gel electrophoresis. Aqueous samples stays in sample wells under a layer of hydrophobic liquid. Sample preparation step prior to electrophoresis is omitted.

### FIELD OF THE INVENTION

The present invention relates in general to devices and methods of gel electrophoresis, and in particular, to sample loading in horizontal gel electrophoresis.

### BACKGROUND OF THE INVENTION

Gel electrophoresis is one of the most frequently utilized tools for biomedical researches and industries. In gel electrophoresis, a gel matrix is connected to electrodes via a running buffer. Samples are loaded into a plurality of sample wells of the gel matrix. Charged molecules in loaded samples migrate from sample wells into gel matrix when electric field being applied. Different molecules migrate in different rates and appear as distinguishable bands in gel matrix. By placement of gel matrix, gel devices and methods have been classified into horizontal gel electrophoresis and vertical gel electrophoresis.

To load samples into sample wells, loading buffer, a mixture to make samples heavier and viscous, is usually a requirement in preparing samples for loading. Otherwise, as aqueous liquid, samples will flow out of sample wells instantly.

In modern biomedical researches and industries, it is routine activities to run gels with large quantity of samples. Rapid electrophoresis process is, therefore, highly desirable to meet its fast pace. In many cases, it turns out that the most time-consuming and labor-intensive step in gel electrophoresis is the requirement of mixing loading buffer into samples, rather than the electrophoresis itself.

Chen, in U.S. Pat. No. 5,549,806, teaches a device and method of high-speed gel electrophoresis. Chen needs, while accelerating electrophoresis speed, to prepare his samples with loading buffer before starting his high-speed gel electrophoresis.

### SUMMARY OF THE INVENTION

It is, therefore, an object of the invention to omit the requirement of sample preparation with loading buffer in horizontal gel electrophoresis. The advantages of the invention are:
(1) It saves time. The most time-consuming step has been omitted.
(2) It reduces labor. Samples can be loaded from reaction tubes directly into sample wells without any preparation.
(3) It protects environment. The waste of disposable plastic wares from sample preparation is avoided. The material used in the invention is biodegradable.

### BRIEF DESCRIPTION OF THE DRAWINGS

FIG. 1a is an illustrative diagram of a gel matrix in traditional horizontal gel electrophoresis.

FIG. 1b is a comparison diagram showing the principle of the invention.

FIG. 2 is a sectional view a Chen's gel apparatus using the invention.

FIG. 3 is a sectional view of a buffer-less gel apparatus using the invention.

### DETAILED DESCRIPTION OF THE INVENTION

Sample molecules, such as DNA, are usually dissolved in water or aqueous reaction buffers. Sample wells of gel matrix are also immersed under aqueous gel running buffer. It is impossible to distinguish two similar aqueous solutions apart without using loading buffer. In practice, it takes a long time and pipetting to mix loading buffer into each sample prior to horizontal gel electrophoresis.

Are there any other easy ways to keep samples in wells without using loading buffer?

Gravity drives a project to fall down. Water, with a specific gravity equal to 1, is the main component of all kinds of aqueous buffers. Load buffer makes sample's specific gravity heavier than 1 so that samples fall down to well bottom under running buffer. In our daily life, we know that oil stays on top of water with a clear interface between them. In a comparison of oil to loading buffer, it shows amazing similarity:
1. Specific gravity: Loading buffer makes sample relatively heavier than running buffer so that sample falls down to well bottom under running buffer. Oil specific gravity is less than water, usually about 0.8-0.88, which means that oil will float on top of the sample. In other words, sample, a specific gravity slightly over 1, is already relatively heavier than oil. No loading buffer is actually necessary!
2. Viscosity: Loading buffer makes sample viscous to slow down sample diffusion. And still sample loading has to be fast to avoid slow diffusion. Oil is hydrophobic. It does not like water and blocks aqueous sample in wells.

Now the strategy of the invention is clear, utilizing a hydrophobic liquid for direct sample loading without sample preparation with loading buffer.

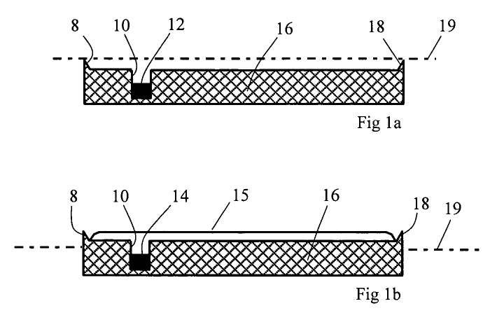

FIG. 1a illustrates a conventional setup of horizontal gel electrophoresis. Gel matrix 16 has sample wells 10 filled with running buffer 19. Sample 12 stays in bottom of wells 10 by loading buffer enhanced gravity and viscosity.

FIG. 1b shows a comparison of the invention to figure la. Buffer 19 is reduced to lower level. Top surface of gel matrix 16 is exposed to air. Then Oil 15 is added on top of gel matrix 16 to fill all sample wells 10. Sample 14 is pipetted directly from reaction, such as PCR tubes, into sample wells 10 without mixing with loading buffer. The specific gravity of sample 14 in PCR reaction is little greater than 1. The specific gravity of oil is less than 1. Thus, sample 14 stays at bottom of sample wells 10. A clear interface distinguishes sample 14 from oil 15, which blocks diffusion of sample 14. Oil 15 can be added on top of gel matrix 16 because:
a. Oil is hydrophobic.
b. Two gel ends, 8 and 18, are elevated higher than other region of gel matrix 16 due to surface tension of gel liquid during gel casting.

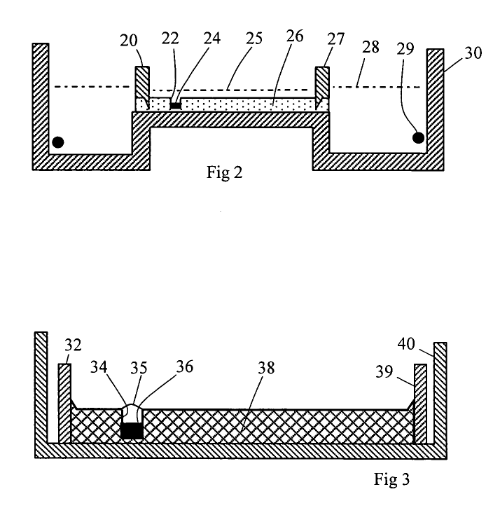

FIG. 2 shows an application of the invention in Chen's gel apparatus 30, a model version similar to U.S. Pat. No. 5,549,806. Two dams, 20 and 27, seal gel matrix 26 at two ends completely, which readily isolates oil 25 from running buffer 28.

FIG. 3 shows a different application of the invention in a buffer-less gel apparatus 40. Gel matrix 38 contacts electrodes, 32 and 39, directly at both ends without running buffer. Oil 35 is added only to wells 34. Sample 36 stays under oil 35.

In all applications, a hydrophobic liquid is the key element of the invention. Many hydrophobic liquids are available from market, such as white mineral oils, vegetable oils, vegetable oil esters, methyl esters, etc. The essential required properties are:

1. Hydrophobic.

2. Specific gravity less than 1.

For further optimizing its application, additional properties should be evaluated as low viscosity, low odor, high flash point for fire safety, no chemical hazard, and biodegradable for environmental protection.

The volume of the hydrophobic liquid varies in different applications. It is required that at least a portion of sample wells is occupied by the hydrophobic liquid.

To tracking sample migration in electrophoresis, tracking dyes can be added into just one of the sample wells prior to electrophoresis. Alternatively, tracking dye can be premixed into oil as a stock solution.

After loading a sample into a well, a flat interface is formed between sample and oil. A bright reflection of light from the interface is used as an indicator to ensure correct loading order along the line of sample wells.

The general operation steps of the invention, an example as shown in FIG. 2, are as follows:

1. Have a bottle containing oil 25.

2. Place gel matrix 26 into gel apparatus 30 with two ends sealed by dams 20 and 27.

3. Pour about 25 ml of oil 25 onto gel matrix 26 to fill sample wells 22.

4. Load samples 24 directly from reaction tube into sample wells 22 without loading buffer.

5. Add running buffer 28 into apparatus 30 and perform electrophoresis.

Although the description above contains specifications, it will apparent to who's skilled in the art that a number of other variations and modifications may be made in this invention without departing from its spirit and scope. The volume of oil 25, for example, can be reduced to 1 ml for covering wells 10 only. Running buffer 28 can be added before addition of oil 25. Thus, the description as set out above should not be constructed as limiting the scope of the invention but as merely providing illustration of the presently preferred embodiment of the invention.

What is claimed is:

1. A device for loading samples into wells of a gel matrix in horizontal gel electrophoresis, comprising
hydrophobic liquid, having a specific gravity less than 1, occupying at least a portion of said wells, floating on top of said samples, forming flat interface with said samples, enabling direct loading of said samples into said wells without addition of a loading buffer.

2. The device as claimed in claim 1 wherein said hydrophobic liquid is biodegradable.

3. A method for loading samples into wells of a gel matrix in a horizontal gel apparatus, comprising steps of
(a). having a device for loading samples into wells of a gel matrix in horizontal gel electrophoresis, said device comprising
hydrophobic liquid, having a specific gravity less than 1, occupying at least a portion of said wells, floating on top of said samples, forming flat interface with said samples, enabling direct loading of said samples into said wells without addition of a loading buffer;
(b). placing said gel matrix into said horizontal gel apparatus;
(c). introducing said hydrophobic liquid to cover at least a portion of said wells; and
(d). loading said samples into said wells without addition of a loading buffer.

4. The method as claimed in claim 3 wherein said hydrophobic liquid has low viscosity less than 10 for easy sample loading.
